(19) United States
(12) Patent Application Publication
(10) Pub. No.: US 2015/0305453 A1
(43) Pub. Date: Oct. 29, 2015

(54) ADJUSTABLE UMBRELLA HOLDER

(71) Applicant: Gina M Gatto-Weising, Harker Heights, TX (US)

(72) Inventor: Gina M Gatto-Weising, Harker Heights, TX (US)

(21) Appl. No.: 14/701,016

(22) Filed: Apr. 30, 2015

Related U.S. Application Data
(63) Continuation-in-part of application No. 13/828,521, filed on Mar. 14, 2013, now abandoned.
(60) Provisional application No. 61/610,889, filed on Mar. 28, 2012.

(51) Int. Cl. A45B 25/00; F16B 2/00; F16M 13/02; F16B 2/06

(52) U.S. Cl. CPC A45B 25/00; F16B 2/065; F16B 2/005; F16M 13/022; A45B 2025/003

(57) ABSTRACT

The disclosure is related holders and clamps, such as umbrella holders. In certain embodiments, an item holder and one or more clamps may be combined to form an umbrella holder. Further, a clamp may include two jaw members that can be tightened to engage a ball joint member of a holder. There may also be an attachment mechanism that also has a ball joint that can be engaged by an end of the clamp opposite the holder. Such a clamp may also be adapted for other uses, such as to engage other items connected to a ball joint.

### CROSS-REFERENCE TO RELATED APPLICATION(S)

The present application is a continuation-in-part of and claims priority to co-pending U.S. patent application Ser. No. 13/828,521, filed Mar. 14, 2013, entitled “Hands-Free Umbrella Holder”; which claims priority to U.S. Provisional Patent Application Ser. No. 61/610,889, filed Mar. 28, 2012, entitled “Hands-Free Umbrella Holder”, the contents of both of which are hereby incorporated by reference in their entireties.

### BRIEF DESCRIPTION OF THE DRAWINGS

FIG. 1 is a diagram of an adjustable umbrella holder, in accordance with certain embodiments of the present disclosure;

FIG. 2 is a diagram of an adjustable umbrella holder, in accordance with certain embodiments of the present disclosure;

FIG. 3 is a diagram of a top view of an adjustable umbrella holder, in accordance with certain embodiments of the present disclosure;

FIG. 4A is a diagram of an adjustable umbrella holder, in accordance with certain embodiments of the present disclosure;

FIG. 4B is a diagram of an adjustable umbrella holder, in accordance with certain embodiments of the present disclosure;

FIG. 5 is a diagram of an adjustable umbrella holder, in accordance with certain embodiments of the present disclosure;

FIG. 6 is a diagram of an adjustable umbrella holder, in accordance with certain embodiments of the present disclosure;

FIG. 7 is a diagram of an adjustable umbrella holder, in accordance with certain embodiments of the present disclosure;

FIG. 8A is a diagram of a receptacle element and a cover element of an adjustable umbrella holder, in accordance with certain embodiments of the present disclosure;

FIG. 8B is a diagram of a receptacle element and a cover element of an adjustable umbrella holder, in accordance with certain embodiments of the present disclosure;

FIG. 8C is a diagram of a receptacle element and an insert element of an adjustable umbrella holder, in accordance with certain embodiments of the present disclosure;

FIG. 9 is a diagram of multiple views of a cup element of an adjustable umbrella holder, in accordance with certain embodiments of the present disclosure;

FIG. 10 is a diagram of multiple views of a jaw element of an adjustable umbrella holder, in accordance with certain embodiments of the present disclosure;

FIG. 11 is a diagram of multiple views of a clamp element of an adjustable umbrella holder, in accordance with certain embodiments of the present disclosure;

FIG. 12 is a diagram of multiple views of an extender element of an adjustable umbrella holder, in accordance with certain embodiments of the present disclosure;

FIG. 13 is a diagram of multiple views of an insert element of an adjustable umbrella holder, in accordance with certain embodiments of the present disclosure;

FIG. 14 is a diagram of multiple views of a cover element of an adjustable umbrella holder, in accordance with certain embodiments of the present disclosure;

FIG. 15 is a diagram of multiple views of an attachment element of an adjustable umbrella holder, in accordance with certain embodiments of the present disclosure;

FIG. 16 is a diagram of multiple views of a clamp element of an adjustable umbrella holder, in accordance with certain embodiments of the present disclosure;

FIG. 17 is a diagram of an adjustable umbrella holder, in accordance with certain embodiments of the present disclosure;

FIG. 18 is a diagram of an adjustable umbrella holder, in accordance with certain embodiments of the present disclosure; and

FIG. 19 is a diagram of multiple positions of an adjustable umbrella holder, in accordance with certain embodiments of the present disclosure.

### DETAILED DESCRIPTION

In the following detailed description of the embodiments, reference is made to the accompanying drawings which form a part hereof, and in which are shown by way of illustrations. Features of the various described embodiments may be combined, other embodiments may be utilized, and structural changes may be made without departing from the scope of the present disclosure. Features of the various embodiments and examples herein can be combined, exchanged, or removed without departing from the scope of the present disclosure.

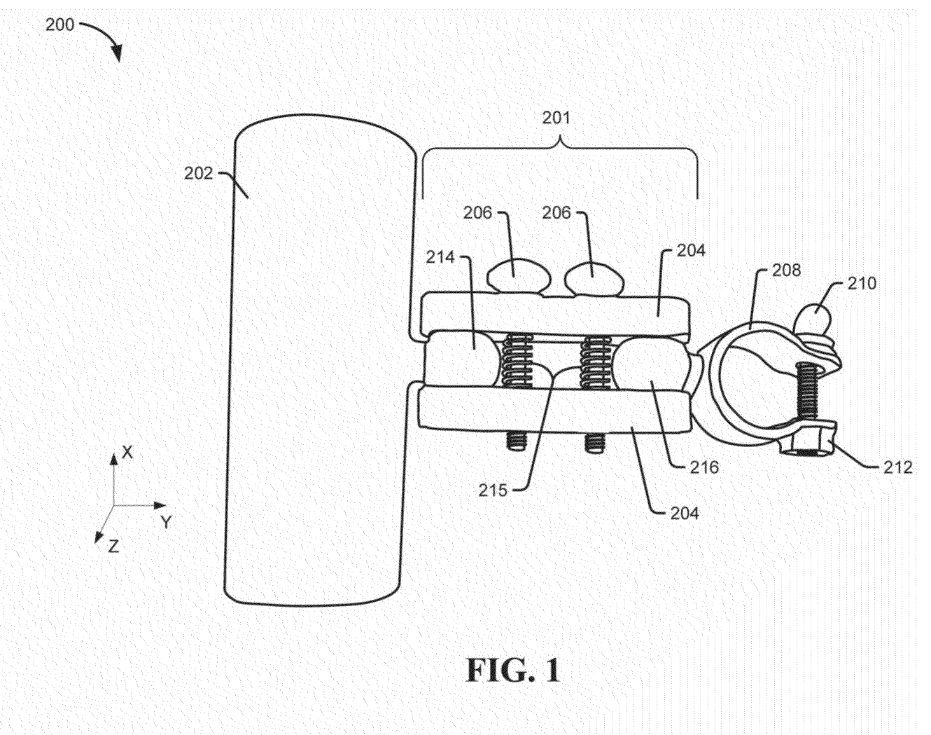

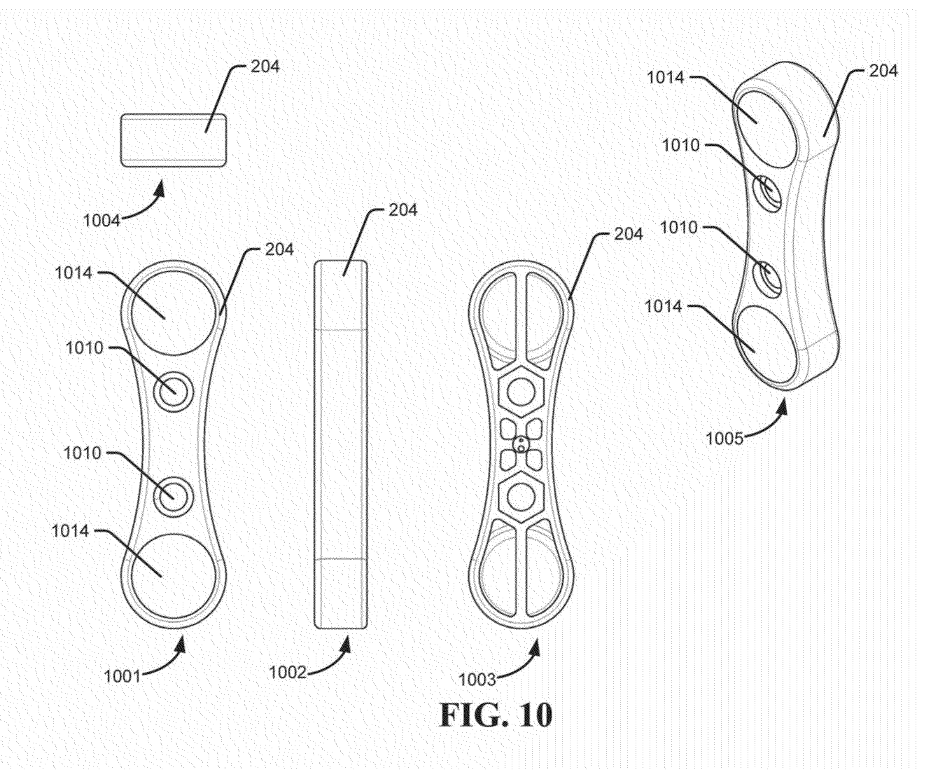

Referring to FIG. 1, certain embodiments of an apparatus that can be used as an adjustable umbrella holder are shown and generally designated 200. While embodiments described herein are referred to as umbrella holders or adjustable umbrella holders, the apparatuses can be used to hold various items. The apparatus 200 can include a holder 202 having a ball joint 214 connected thereto. The apparatus 200 may have one or more elements that are articulable via a ball and socket joint or other means. For example, the ball joint 214 may be received between an end of a first clamp mechanism 201 formed by two jaw members 204, allowing the holder 202 to be articulable with respect to the first clamp mechanism 201. The two jaw members 204 may have two threaded fasteners (such as screws 206) inserted therethrough, where tightening of a screw 206 tightens the first clamp mechanism 201 about the ball joint 214. The screws 206 may each have a wing nut drive mechanism, as shown, or may have other drive mechanisms, such as standard head, a Phillips head, a torx head, a square socket, a hex head, or any other type of fastener drive feature. Other embodiments of the first clamp mechanism 201 may include one screw 206 or more than two screws 206. One or more of the screws 206 may include a spring 215, through which the screw 206 is inserted, and which is positioned in-between the two jaw members 204. The springs 215 may provide pressure on each of the jaw members 204 to oppose a clamping force supplied by the screws 206, which pressure may help the first clamp mechanism 201 keep a secure fit about the ball joint 214 and ball joint 216. In certain embodiments, the jaw members 204 may include a curved depression (as shown in FIG. 10) therein to substantially conform to at least a portion of the curvature of ball joint 214.

The first clamp mechanism 201 may also receive a second ball joint 216 at a second end of the first clamp mechanism 201. In some embodiments, the second end of the first clamp mechanism 201 may be opposite the first end of the first clamp mechanism 201; however, variations may include placement of a ball joint in a middle portion of the first clamp mechanism 201 or at other locations between the jaw members 204. In some embodiments, the second ball joint 216 may be coupled to an attachment mechanism, such as a second clamp 208. The second clamp 208 may include a fastening mechanism, such as a screw 210 and nut 212, to allow attachment to another device, such as a shaft or dowel. The second ball joint 216 may be connected to other types of mechanisms, such as described herein.

The ball joint 214 allows the holder 202 to be articulable, for example rotatable approximately 180 degrees or more of range of motion in the z-axis direction as depicted in FIG. 1. In addition, ball joint 214 allows articulable movement of the holder 202 with respect to the x-axis direction and the y-axis direction as depicted in FIG. 1. Thus, the ball joint 214 allows for articulable movement via pivoting or tilting movement of the holder 202 in three dimensions (X, Y, and Z) Further, the ball joint 214 allows the holder 202 to be rotated in the X-Z plane approximately 360 degrees. Even further, ball joint 216 allows for tilting or pivoting movement of the second clamp 208 with respect to the z-axis direction, x-axis direction, and the y-axis direction, or rotation in the X-Z plane. However, in some embodiments, a movement restriction element could be added to disallow movement of the holder 202 in one or more of the three dimensions.

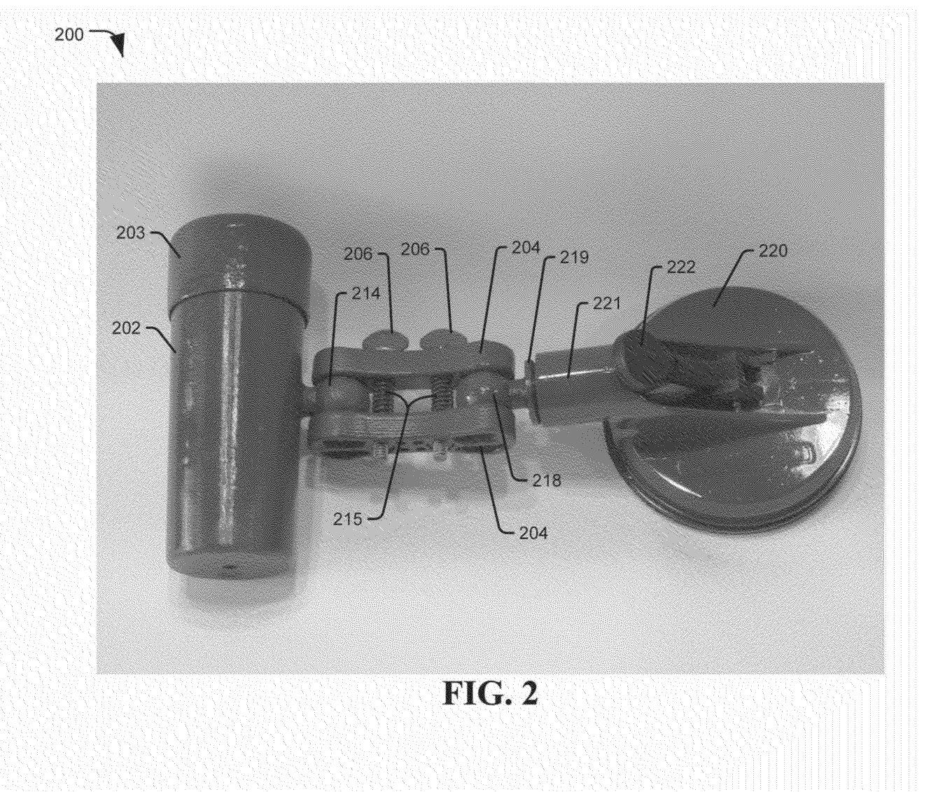

FIG. 2 depicts certain embodiments of an adjustable umbrella holder 200 including a selectively releasable suction mounting mechanism 220. The suction mounting mechanism 220 may include a lever 222 that allows a user to engage or disengage the suction mounting mechanism 220 from a surface. The suction mounting mechanism 220 may be connected to the first clamp mechanism via a shaft insert 219 having a ball joint 218. The shaft insert 219 may be formed to tightly fit within a receptacle 221 of the suction mounting mechanism 220. In some embodiments, the shaft insert 219 may include a longitudinal element that extends within the receptacle 221.

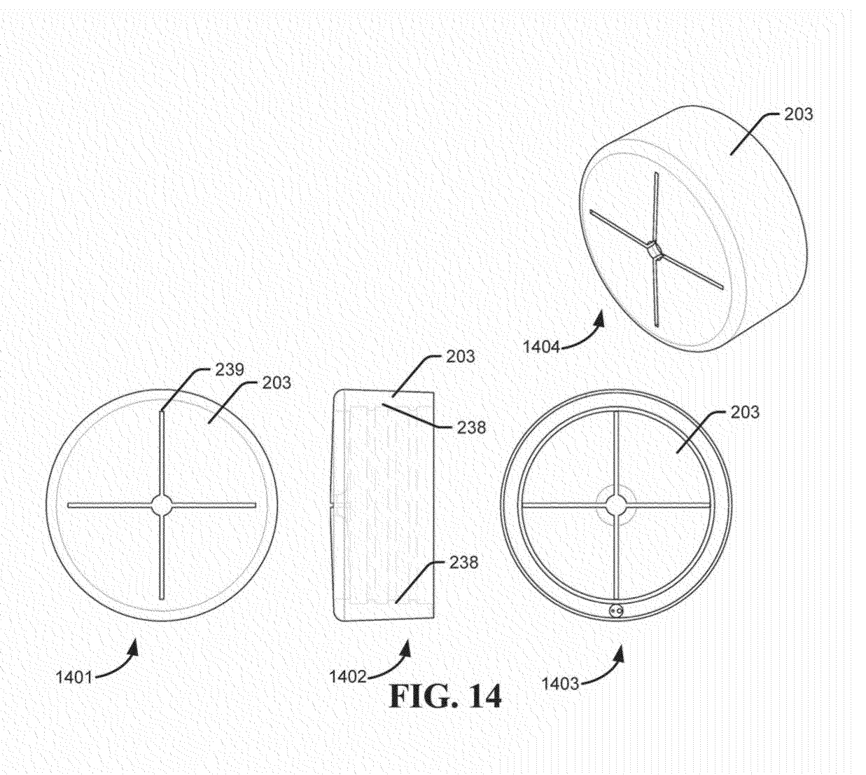

The adjustable umbrella holder 200 can also include a cover 203 that can be selectively detached from the holder 202. The cover 203 can be used in conjunction with an umbrella handle or other devices, such as via openings 213 shown in FIG. 14, to provide additional stability for holding an umbrella handle or other devices steady in the holder 202. In certain embodiments, the cover 216 may not include an opening and can be a solid piece that forms a sealed container with the holder 216, for use with items other than an umbrella. The cover 203 may be made of rubber, plastic, metal, a composite, or any combination thereof

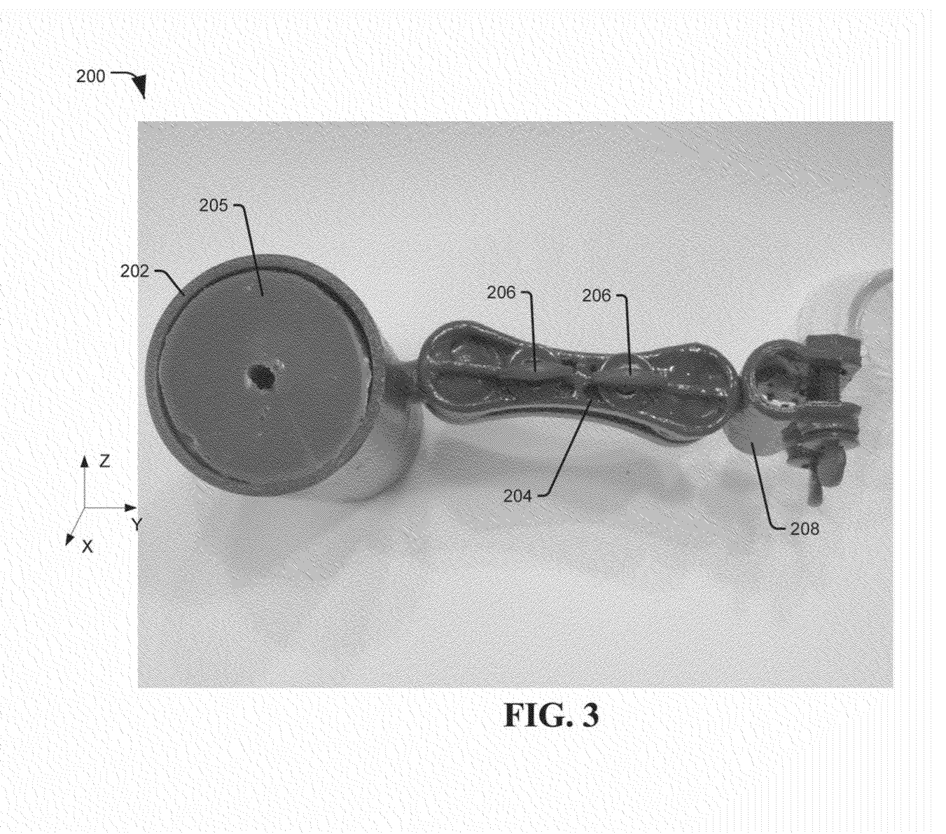

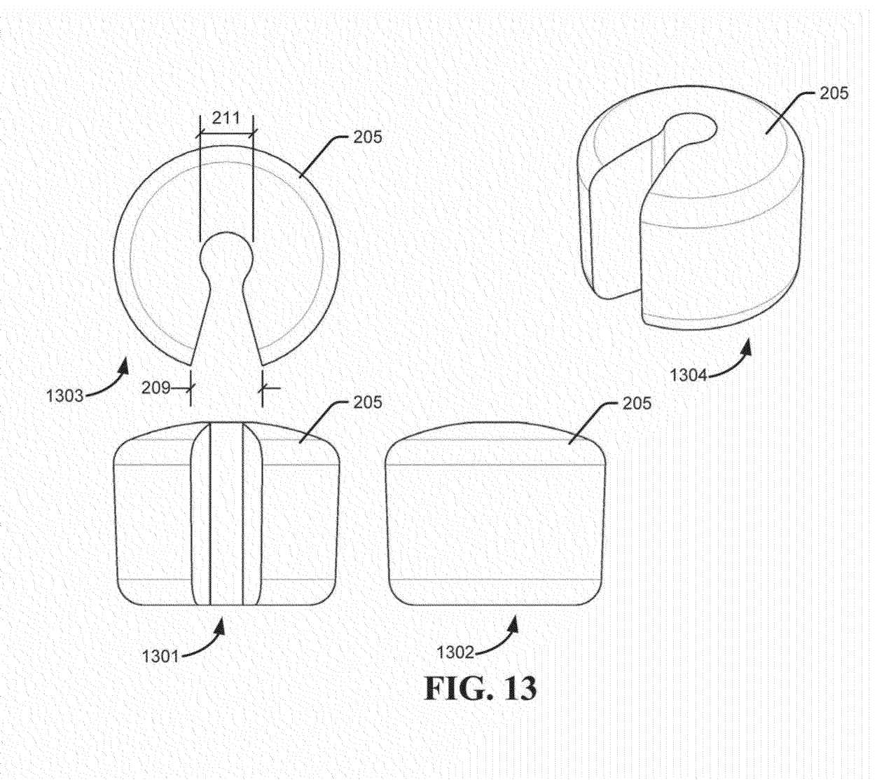

FIG. 3 depicts a top view of certain embodiments of an adjustable umbrella holder 200. As shown, the adjustable umbrella holder 200 may include an insert 205. The insert 205 can be used in conjunction with an umbrella handle or other devices, such as via openings 209 and 211 shown in FIG. 13, to provide additional stability for holding an umbrella handle or other devices steady in the holder 202. The insert 205 may be made of rubber, plastic, metal, a composite, or any combination thereof. As seen in FIG. 3, the jaw members 204 allow rotation about the ball joints 214 and 216 to move the jaw members 204 in the z-axis direction and the x-axis direction with respect to the holder 202 of the attachment mechanism 208. Further, the ball joints 214 and 216 may allow for pivoting movement of the holder 202 relative to the attachment mechanism 208 in any combination of the x-axis direction, the y-axis direction and the z-axis direction.

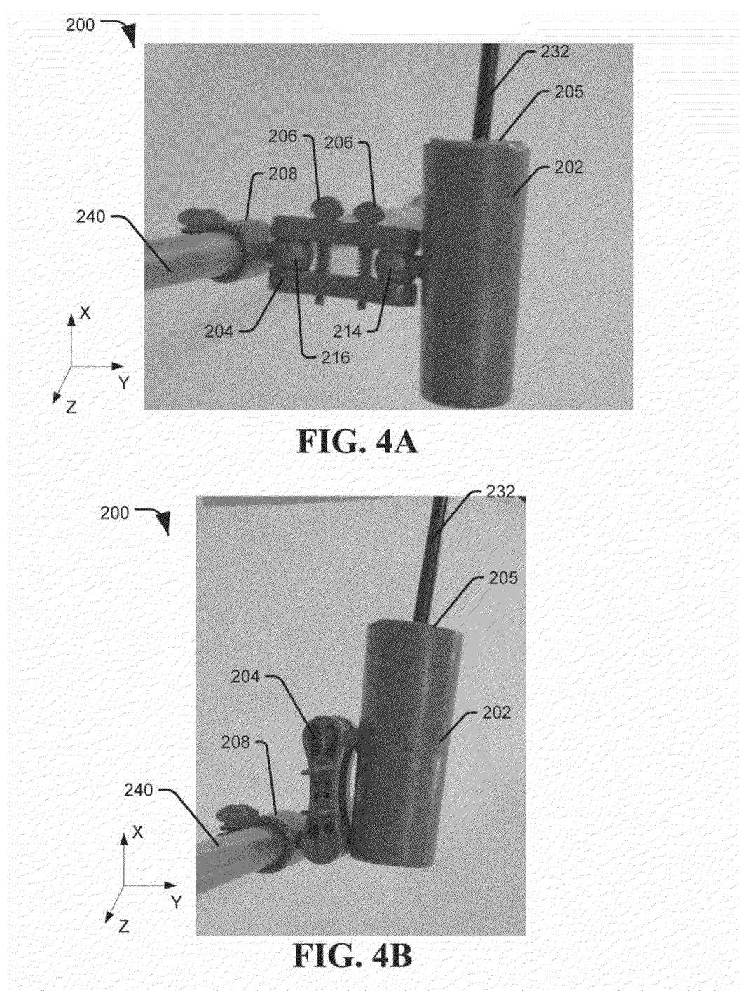

FIG. 4A depicts the adjustable umbrella holder 200 including an umbrella handle in the holder 202 with the umbrella's shaft 232 extending through the insert 205. FIG. 4A also depicts attachment mechanism 208 attached to a cross bar 240. FIG. 4B depicts the adjustable umbrella holder 200 in which the first clamp mechanism 201 positioned in an alternate position, where a length of the jaw member 204 is positioned in the x-axis direction rather than in the y-axis direction as shown in FIG. 4A.

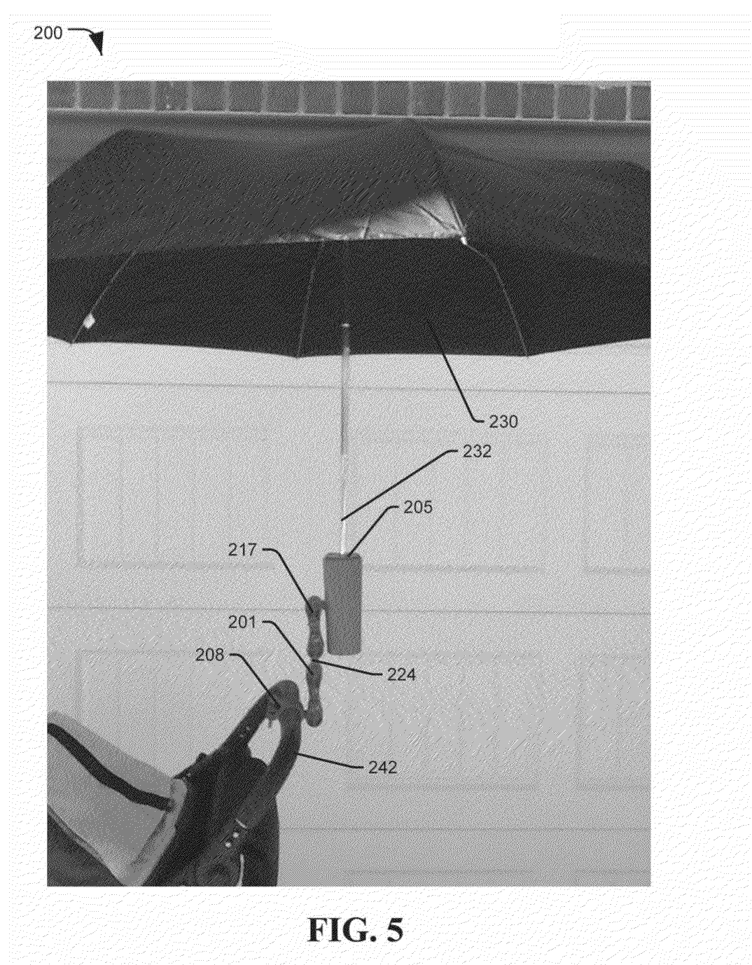

FIG. 5 depicts the adjustable umbrella holder 200 attached to a horizontal cross member of a stroller 242, the adjustable umbrella holder 200 including an umbrella handle in the holder 202 and the shaft 232 extending through the insert 205. FIG. 5 also depicts a second clamp mechanism 217 coupled to the first clamp mechanism 201 by an extender element 224. The second clamp mechanism 217 may have a similar, or exactly identical, construction as the first clamp mechanism 201.

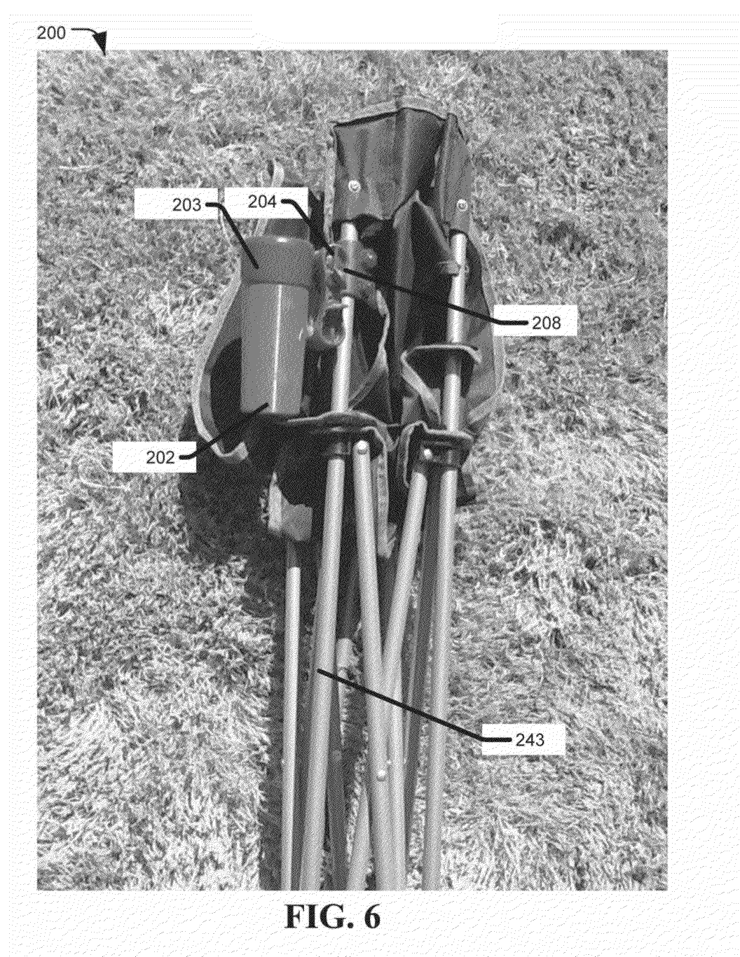

FIG. 6 depicts the adjustable umbrella holder 200 attached to a vertical bar of a collapsible chair 243. In this example, the umbrella or other shade device may be removed from the adjustable umbrella holder 200, which may be left attached to the collapsible chair 243 for storage.

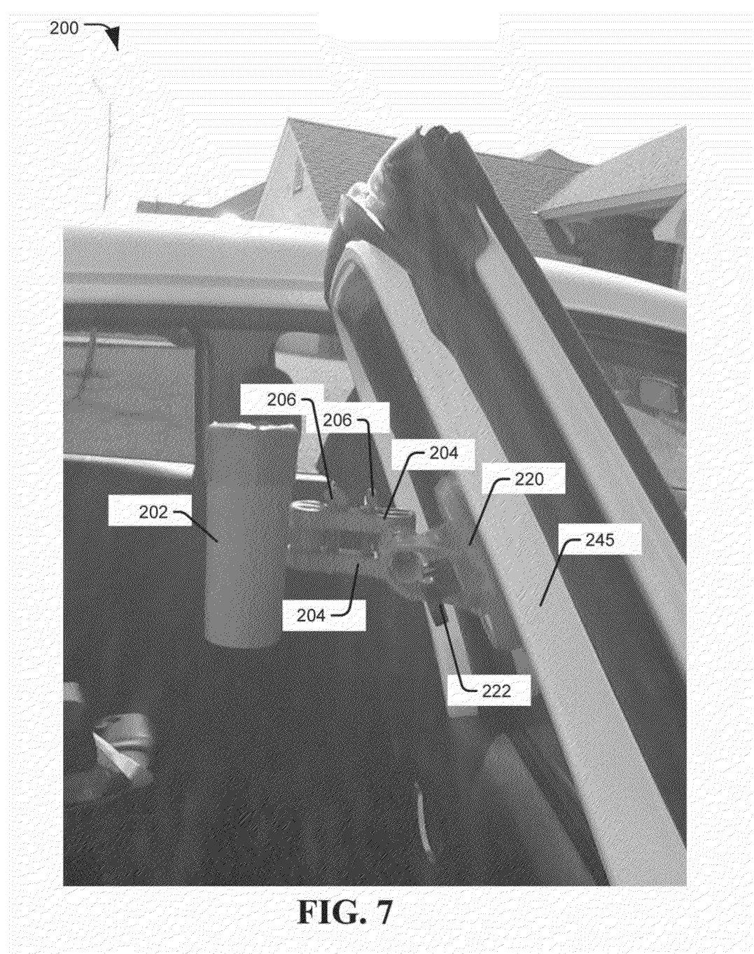

FIG. 7 depicts the adjustable umbrella holder 200 attached to a window of an automobile door 245. While FIG. 7 shows the adjustable umbrella holder 200 attached to an inside of the window, the adjustable umbrella holder 200 of FIG. 7 can also attach to the outside of an automobile window, and can attach to any other surface or material that allows a suction holder to attach, such as a wall or door. The adjustable umbrella holder 200 can also be attached to a side of an appliance via the suction mounting mechanism 220. Once attached, the holder 202 and the jaw members 204 may be pivoted, rotated, and otherwise adjusted to provide a selected positioning for the element to be placed in the holder 202.

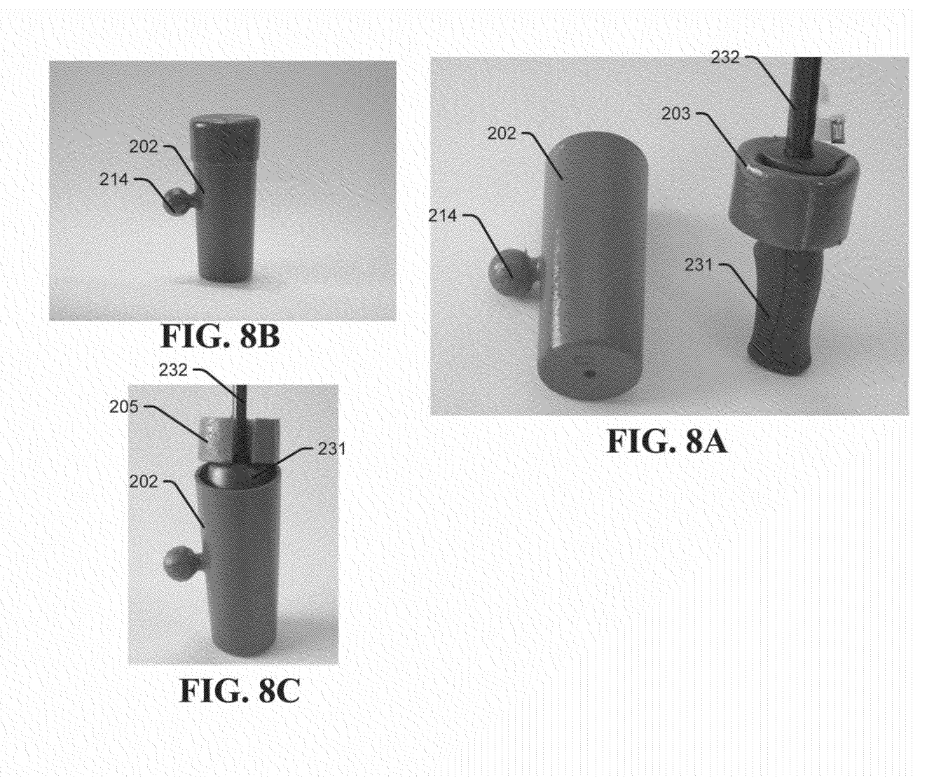

FIG. 8A depicts the holder 202 and the cover 203 with an umbrella handle 231 inserted through the cover 203. The cover 203 may be sized to fit over an opening of the holder 202 and optionally to grip an exterior surface of the holder 202 to secure the umbrella handle 231. In some embodiments, the cover 203 may be provided with a clamping element, which may be tightened about a circumferential surface of the cover 203 to secure the cover 203 to the holder 202.

FIG. 8B depicts the holder 202 with the cover 203 secured to the holder 202. In some embodiments, the cover 203 may be formed from a flexible material, such as a rubber or plastic material, which may have an interior diameter that is slightly smaller than an exterior diameter of the holder 202. The cover 203 may stretch or otherwise deform to fit over the holder 202 and to apply a hoop stress to grip the holder 202.

FIG. 8C depicts the holder 202 with the insert 205 and an umbrella shaft 232 inserted through the insert 205 such that the umbrella handle 231 is below the insert 205, as the insert 205 is about to be inserted or removed from the holder 202. In some embodiments, the insert 205 may be formed from a flexible material have an outer diameter that is approximately equal to an interior diameter of the holder 202. In some embodiments, the holder 202 may have a slight taper to its interior diameter, such that the insertion of the insert 205 may apply a compression force to the insert 205 to secure the insert 205. In some embodiments, the holder 202 may be substantially cylindrical and may have a substantially uniform internal diameter. Other embodiments are also possible.

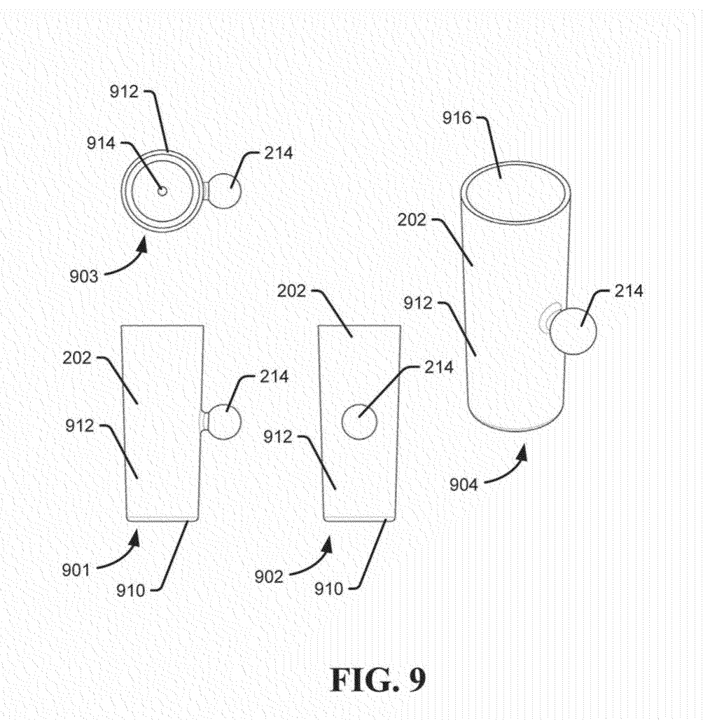

FIG. 9 depicts multiple views of the holder 202, including a side view 901, a front view 902, a top view 903, and a perspective view 904. The holder 202 may have a ball joint 214 attached to a side of the holder 202. The ball joint 214 may be formed as a unitary element of the holder 202, such as by injection molding, three-dimensional printing, or machining In other embodiments, the ball joint 214 may be attached to the holder 202 via an attachment device, such as a clamp, a screw, nail, insert, another fastening element, or any combination thereof. The ball joint 214 may be coated or dipped in rubber, or some other material, that provides a higher coefficient of friction when the ball joint is joined with the socket 1014 (in FIG. 10). Also, the ball joint 214 may be textured, such as with ridges, a notch, a scratch, an incision, or bumps thereon, which may provide a higher coefficient of friction when the ball joint 214 is joined with the socket 1014. In some examples, the ball joint 214 may be both dipped and textured. Further, any or all parts of the adjustable umbrella holder 202 may painted, coated, dipped, textured, or any combination thereof. The socket 1014 may also be coated or dipped in rubber, or some other material, that provides a higher coefficient of friction when the socket 1014 is joined with ball joint 214; or may be textured, such as with ridges, a notch, a scratch, an incision, or bumps thereon; or may have any combination of materials or textures to form a better a grip between the socket 1014 and the ball joint 214.

The holder 202 may be formed like a cup, with a bottom portion 910 connected to a curved side wall portion 912. In some embodiments, the bottom portion 910 can include one or more holes 914. The holder 202 may have a substantially open receptacle top 916. In some embodiments, a cover 203 or an insert 205 may be provided to fit the open receptacle top 916.

FIG. 10 depicts multiple views of the jaw member 204, including a top view 1001, a first side view 1002, a bottom view 1003, a second side view 1004, and a perspective view 1005. The jaw member 204 may be formed as a unitary element, such as by injection molding or three-dimensional printing. In other embodiments, jaw member 204 may be formed of multiple pieces. The jaw member 204 may include one or more holes 1010 that are adapted to fit a screw to pass through the holes 1010. The jaw member 204 may also include one or more tightening fasteners, such as one or more screw nuts 1012, that may be formed as a unitary piece of jaw member 204 or as separate pieces. In certain embodiments, the jaw members 204 may include a curved depression 1014 (e.g. socket) therein to substantially conform to at least a portion of the curvature of ball joint 214, 216, or 218.

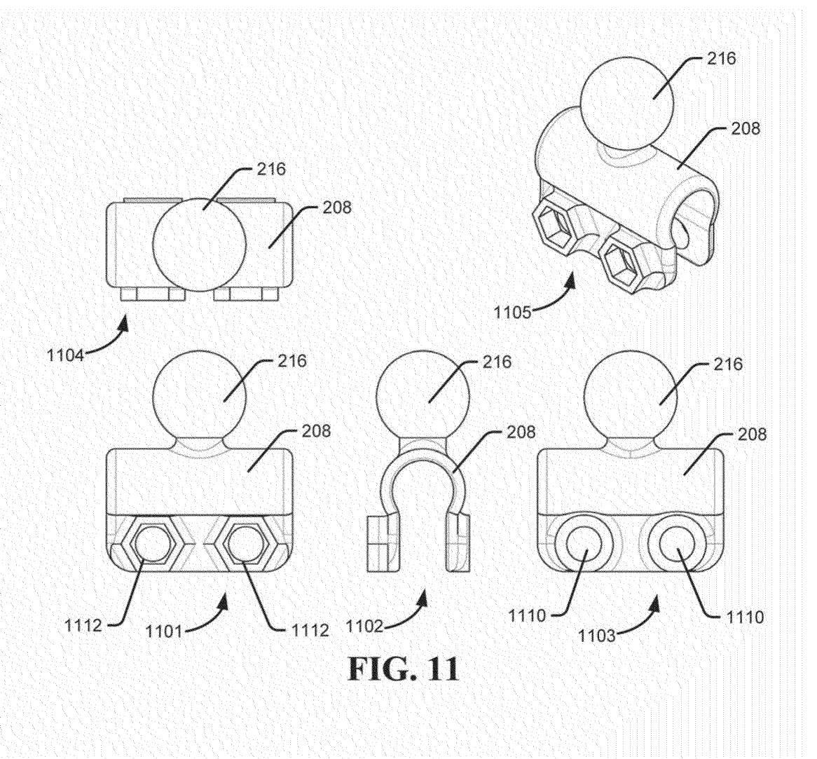

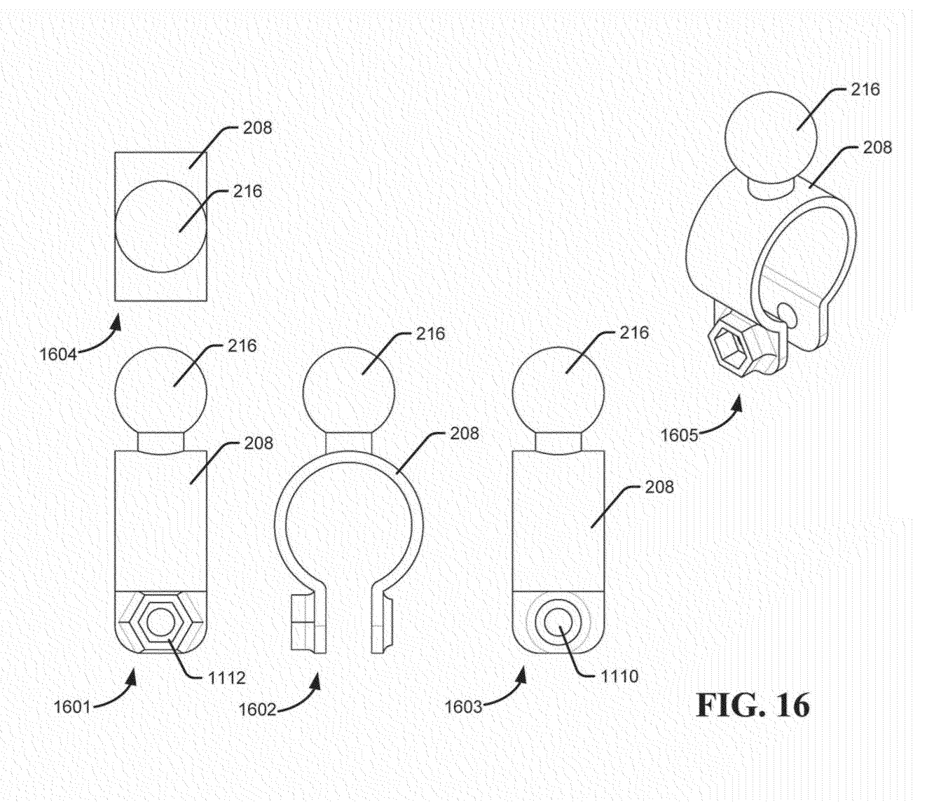

FIG. 11 depicts multiple views of the attachment mechanism 208, including a first side view 1101, a second side view 1102, a third side view 1103, a top view 1104, and a perspective view 1105. The attachment mechanism 208 may be formed as a unitary element, such as by injection molding or three-dimensional printing. In other embodiments, attachment mechanism 208 may be formed of multiple pieces. The attachment mechanism 208 may include one or more holes 1110 that are adapted to fit a tightening fastener, such as a screw, to pass through the holes 1110. The attachment mechanism 208 may also include one or more tightening fasteners, such as one or more screw nuts 1112, that may be formed as a unitary piece of attachment mechanism 208 or as separate pieces. In some embodiments, attachment mechanism 208 may include more or less than two holes for tightening fasteners, such as depicted in FIG. 16.

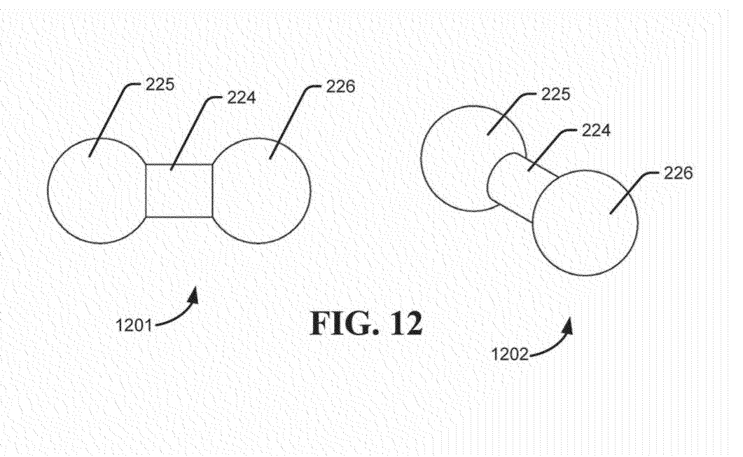

FIG. 12 depicts multiple views of the extender element 224, including a side view 1201 and a perspective view 1202. The extender element 224 may be formed as a unitary element, such as by injection molding or three-dimensional printing. In other embodiments, extender element 224 may be formed of multiple pieces. The extender element 224 may include a first ball joint 225 at a first end of the extender element 224 and a second ball joint 226 at a second end of the extender element 224.

FIG. 13 depicts multiple views of the insert 205, including a first side view 1301, a second side view 1302, a top view 1303, and a three-dimensional view 1304. The insert 205 may be formed as a unitary element, such as by injection molding or three-dimensional printing. In other embodiments, insert 205 may be formed of multiple pieces. The insert 205 may include an opening 209 that is adapted to fit a shaft 232 of an umbrella 230. The opening 209 may provide a tapered opening that extends to a substantially circular hole 211 that is adapted to fit the shaft 232 of the umbrella 230. When inserted into the holder 202, the holder 202 may at least partially compress the insert 205, causing the edges of the opening 202 to push toward one another, reducing the internal diameter of the hole 211 and applying a hoop stress to the shaft 232. The hoop stress may secure the shaft 232 from moving within the hole 211 and may secure the insert 205 within the holder.

FIG. 14 depicts multiple views of the cover 203, including a top view 1401, a side view 1402, a bottom view 1403, and a perspective view 1404. The cover 203 may be formed as a unitary element, such as by injection molding or three-dimensional printing. In other embodiments, cover 203 may be formed of multiple pieces. The cover 203 may include an opening 239 that is adapted to fit an umbrella handle 230. In some embodiments, the opening 239 may include a hole and one or more slits to provide adjustability with respect to the size of the hole so that the handle of an umbrella or another device may be inserted through the opening 239. In some embodiments, the cover 203 may have internal side walls 238 that have threads to allow attachment to a threaded end of a holder or shaft. In some embodiments, the internal side walls 238 can include smooth wall surfaces or rough wall surfaces (such as ridges, bumps, texture features, or any combination thereof), both of which may allow the cover 203 to be pushed onto or pulled off of a holder.

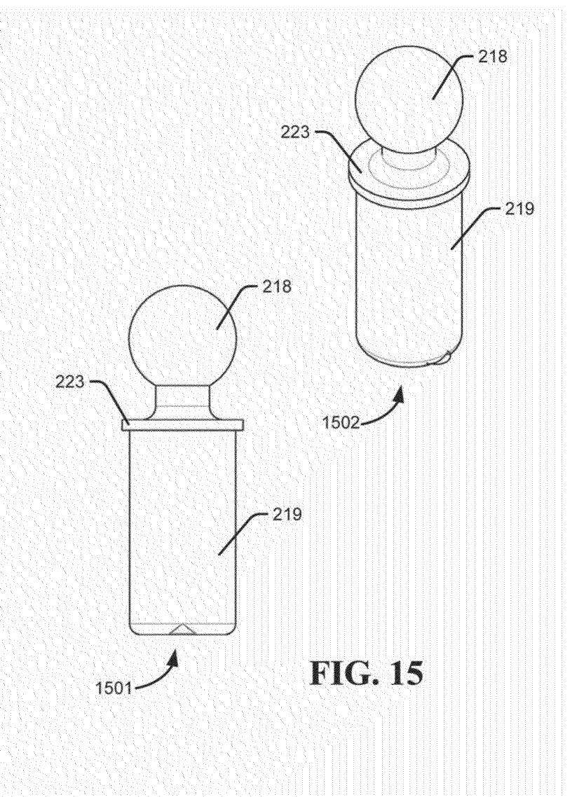

FIG. 15 depicts multiple views of the shaft insert 219, including a side view 1501 and a perspective view 1502. The shaft insert 219 may be formed as a unitary element, such as by injection molding or three-dimensional printing. In other embodiments, shaft insert 219 may be formed of multiple pieces. Shaft insert 219 may be adapted to fit within another device, such as the receptacle 221 of the selectively releasable suction mounting mechanism 220. Shaft insert 219 may have a ridge or lip 223 which can provide a stopping point when the shaft 219 is inserted within a receptacle. Further, in some embodiments, the shaft insert 219 may include a longitudinal ridge or notch (not shown) extending along a length of the shaft insert 219, which may be sized to mate with a corresponding notch or ridge on an interior surface of the receptacle 221. The notch/ridge features may cooperate to align the shaft insert 219 within the receptacle 221 and to prevent the shaft insert 219 from turning within the receptacle 221.

FIG. 16 depicts multiple views of the attachment mechanism 208, including a first side view 1601, a second side view 1602, a third side view 1603, a top view 1604, and a perspective view 1605. The attachment mechanism 208 may be formed as a unitary element, such as by injection molding or three-dimensional printing. In other embodiments, attachment mechanism 208 may be formed of multiple pieces. The attachment mechanism 208 may include one or more holes 1110 that are adapted to fit a tightening fastener, such as a screw, to pass through the holes 1110. The attachment mechanism 208 may also include one or more tightening fasteners, such as one or more screw nuts 1112, that may be formed as a unitary piece of attachment mechanism 208 or as separate pieces. In some embodiments, the holes 1110 may be threaded and sized to mate with corresponding threads of a fastener, such as a screw.

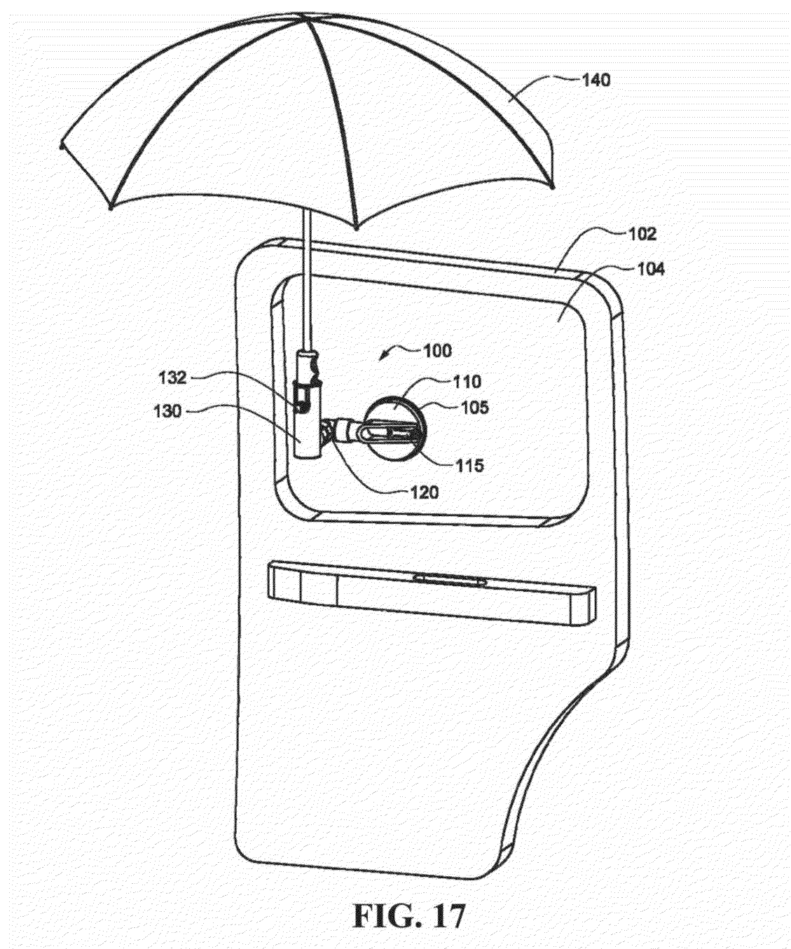

Referring to FIG. 17, a perspective side view of an umbrella holder mounted to the interior of an automobile window is shown. Reference numeral 100 generally designates an umbrella holder assembly. Assembly 100 can be mounted to the interior side of an automobile door 102 on a window 104. The system 100 includes attachment means 110, armature 120, and holder 130.

Specific embodiments of attachment means 110 can have a suction cup 105 formed of rubber or other material that may be used to form a seal on window 104 of sufficient strength to support the weight of umbrella 140 in holder 130. Attachment means 110 can provide a release mechanism 115 in specific embodiments whereby assembly 100 can be attached or detached from window 104. In the view of FIG. 17, the release mechanism 115 is in the closed (or attached) position. In some embodiments, the attachment means 110 may couple to the armature 120, and the coupling between the attachment means 110 and the armature 120 may allow for at least some movement of the holder 130 relative to the attachment means 110.

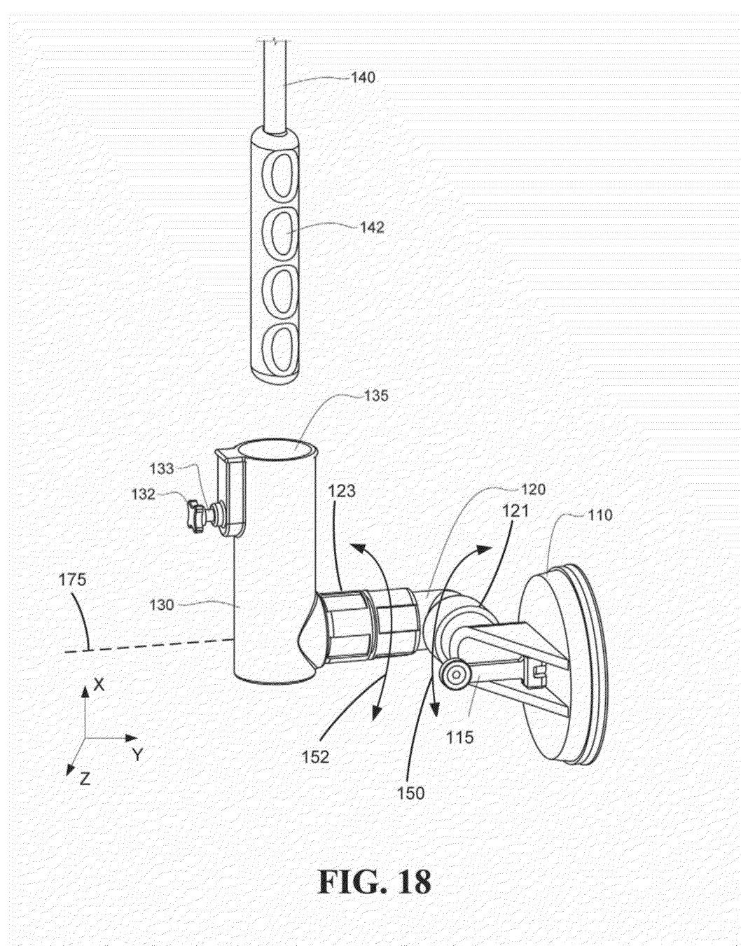

FIG. 18 is a perspective front view of an umbrella holder. In the view of FIG. 18, the release mechanism 115 is in the open (or released) position. Holder 130 can provide receptacle 135 mounted on armature 120. Receptacle 135 has a diameter sufficiently great to accommodate the width umbrella handle 142. Tightener 132 can provide pin 133 that can be selectively tightened onto umbrella handle 142 to secure umbrella 140 in an upright position, and can be selectively loosened to release umbrella handle 142 from receptacle 135.

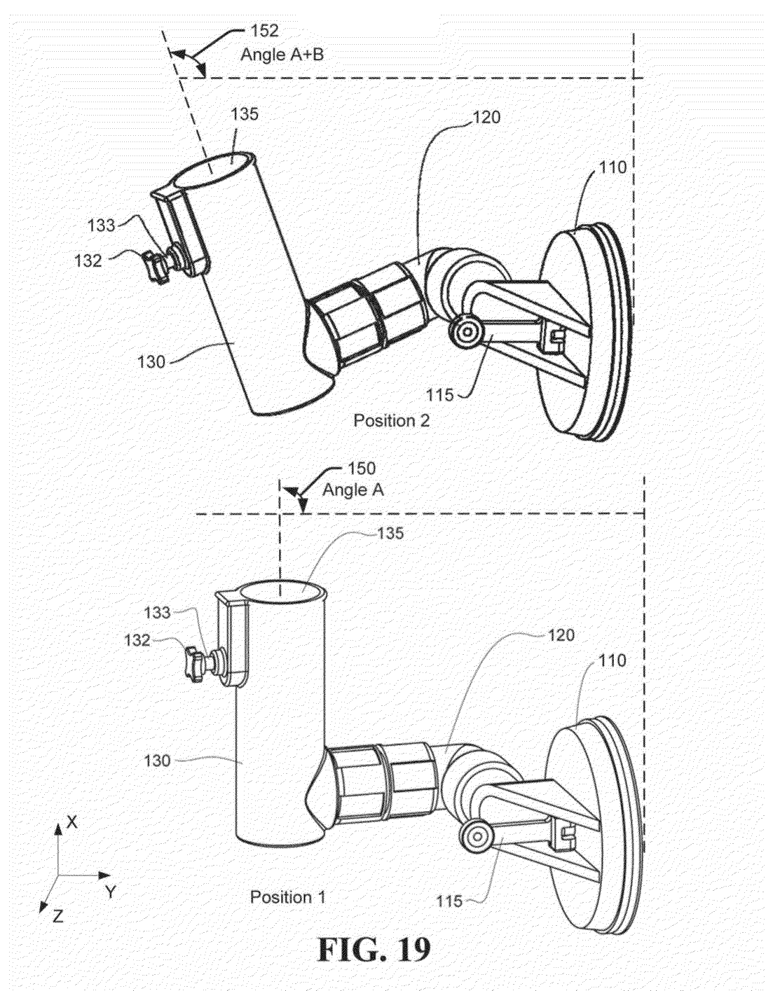

Armature 120 which connects attachment means 110 and holder 130 can be articulated in specific embodiments. An articulable armature allows a user to adjust the position of the umbrella to maximize its beneficial effect and to selectively fix the umbrella in a desired position and selectively unfix the position to choose a different position. The position of the umbrella holder is adjustable along the horizontal, vertical and diagonal. For example, the armature 120 may be articulable in a first direction 150 to allow the receptacle 135 and the holder 130 to increase or decrease an angle (e.g. Angle A) between the holder 130 and the y-axis direction, such as shown in FIG. 19. Further, the armature 120 may be articulable in a second direction 152 to allow the receptacle 135 and the holder 130 to increase or decrease an angle between the holder 130 and the z-axis direction; that is, the holder 130 can pivot about an axis 175 in the y-axis direction. This adjustability can be achieved with two twistable joints built into joint 121 and joint 123. Certain embodiments may implement one or both of such articulable joints.

Certain embodiments provide a selectively releasable lock mechanism such as a releasable latch to fix the angle or other position of the armature in a desired position. The selectively releasable suction mounting mechanism of the preferred embodiment is adaptable for mounting to any suitable smooth surface other than automobile window glass, such as metal, ceramic, plastic or even smooth, polished stone.

For vehicles such as vans that have sliding doors such that an internal mount would be problematic, the present umbrella holder is easily adapted for external mounting.

Alternative embodiments provide an umbrella holder that can be selectively mounted to a baby carrier-type car seat. With the carrier/car seat mounted embodiments, one can protect a baby from the elements in a hands-free fashion with the umbrella secured in an upright position over the carrier and then transfer the umbrella to the automobile holder when fastening the carrier in to the car seat.

FIG. 19 is a diagram of multiple positions of an adjustable umbrella holder, in accordance with certain embodiments of the present disclosure. Position 1 shows the holder 130 in a substantially similar position as shown in FIGS. 17 and 18. Position 1 shows the receptacle to have an “Angle A” 150 with respect to an axis normal to a plane of the attachment mechanism 110. Position 2 shows the holder 130 to have an “Angle A+B” 150 with respect to the axis normal to the plane of the attachment mechanism 110. The articulation between position 1 and position 2, and various other positions, occurs due to the articulation direction 150, as shown in FIG. 18.

Many modifications and other embodiments of the umbrella holders described herein will come to mind to one skilled in the art to which this disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

The machines and manufactures (and improvements thereof) described herein are particularly useful improvements for umbrella holders. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, any of the embodiments of an adjustable umbrella holder as described herein may be constructed with solid pieces, hollow pieces, or any combination thereof. Further, the construction of the pieces may be made out of any substantially rigid material that is at least rigid enough to accomplish the purposes thereof, such as plastic, metal, wood, composite, other materials, or any combination thereof. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An umbrella holder comprising:
a receptacle for receiving a handle of an umbrella;
a first ball joint connected to the receptacle;
a first clamp mechanism configured to receive the first ball joint at a proximate end of the first clamp mechanism and to receive a second ball joint at a distal end of the first clamp mechanism; and
the second ball joint connected to an attachment mechanism.

2. The umbrella holder of claim 1 further comprising:
the first clamp mechanism includes two jaw members substantially parallel to each other, and forming a clamp to hold the first ball joint between the two jaw members.

3. The umbrella holder of claim 2 further comprising:
the first clamp mechanism includes at least one screw passing through a top jaw member of the two jaw members and attaching to a nut portion at a bottom jaw member of the two jaw members, where tightening of the at least one screw causes the two jaw members to apply additional force to the first ball joint.

4. The umbrella holder of claim 3 further comprising:
a spring through which the screw passes, the spring located between the two jaw members.

5. The umbrella holder of claim 1 further comprising a cover that can be removably attached to the receptacle.

6. The umbrella holder of claim 1 further comprising an insert adapted to fit within the receptacle and adapted to fit around a shaft of an umbrella.

7. The umbrella holder of claim 3 further comprising the nut portion is built into the bottom jaw member.

8. The umbrella holder of claim 1 further comprising the attachment mechanism is a clamp.

9. The umbrella holder of claim 8 further comprising the clamp has one screw.

10. The umbrella holder of claim 8 further comprising the clamp has two screws.

11. The umbrella holder of claim 1 further comprising the attachment mechanism is a shaft adapted to be inserted into a second receptacle of a mounting mechanism.

12. The umbrella holder of claim 11 further comprising the mounting mechanism is a selectively releasable suction mounting mechanism.

13. The umbrella holder of claim 1 further comprising:
an extender with a third ball joint and a fourth ball joint;
the first clamp mechanism receiving the third ball joint at the distal end of the first clamp mechanism; and
a second clamp mechanism receiving the fourth ball joint at a proximate end of the second clamp mechanism and receiving the second ball joint at a distal end of the second clamp mechanism.

14. The umbrella holder of claim 1 further comprising the first ball joint is coated in a material that increases a coefficient of friction between the first ball joint and the first clamp mechanism.

15. The umbrella holder of claim 14 further comprising at least a portion of the first clamp mechanism is coated in a material that increases a coefficient of friction between the first ball joint and the first clamp mechanism.

16. The umbrella holder of claim 1 further comprising at least a portion of the first clamp mechanism is textured to increase a coefficient of friction between the first ball joint and the first clamp mechanism.

17. The umbrella holder of claim 16 further comprising the first ball joint is textured to increase a coefficient of friction between the first ball joint and the first clamp mechanism.

18. The umbrella holder of claim 2 further comprising at least one of the two jaw members includes a socket to receive the first ball joint.

19. The umbrella holder of claim 18 further comprising both of the two jaw members include sockets to receive the first ball joint.

20. The umbrella holder of claim 1 further comprising an insert adapted to wrap about a portion of a shaft or handle of an umbrella and adapted to fit inside the receptacle.

21. An apparatus comprising:
a receptacle for receiving an item;
a first ball joint connected to the receptacle;
a first clamp mechanism configured to receive the first ball joint at a proximate end of the first clamp mechanism and to receive a second ball joint at a distal end of the first clamp mechanism; and
the second ball joint connected to an attachment mechanism.

22. The apparatus of claim 21 further comprising the clamp mechanism includes a tightening mechanism.

23. The apparatus of claim 21 further comprising the receptacle is articulable in at least two axes.
